(19) United States
(12) Patent Application Publication
(10) Pub. No.: US 2011/0117398 A1
(43) Pub. Date: May 19, 2011

(54) CAP-UP PLATE AND SECONDARY BATTERY HAVING THE SAME

(75) Inventor: Cho-Hee Kang, Yongin-si (KR)

(73) Assignee: Samsung SDI Co., Ltd., Yongin-si (KR)

(21) Appl. No.: 12/887,433

(22) Filed: Sep. 21, 2010

(30) Foreign Application Priority Data
Nov. 18, 2009 (KR) 10-2009-0111399

(51) Int. Cl. H01M 2/12; H01M 2/04; H01M 2/26

(52) U.S. Cl. 429/56; 429/175; 429/170

(57) ABSTRACT

A cap-up plate and a cylindrical secondary battery having the cap-up plate are disclosed. In one embodiment, the cap-up plate includes i) a base plate and ii) a terminal extending from a portion of the base plate, wherein the terminal has a flat portion substantially parallel with the base plate, and wherein the flat portion comprises an end which is located over the portion of the base plate. The end of the flat portion may overlap with the portion of the base plate along a direction substantially perpendicular to the base plate.

### CROSS-REFERENCE TO RELATED APPLICATIONS

This application claims priority to and the benefit of Korean Patent Application No. 10-2009-0111399, filed on Nov. 18, 2009, in the Korean Intellectual Property Office, the entire content of which is incorporated herein by reference.

### BACKGROUND

1. Field of the Invention

Disclosed embodiments relate to a cap-up plate that is used for the cap assembly of a secondary battery and makes it possible to increase the size of a gas outlet while improving weldability, and a cylindrical secondary battery having the cap-up plate.

2. Discussion of the Related Technology

In general, with development of function and decrease of weight of mobile wireless devices, such as a video camera, a portable phone, and a portable computer, secondary batteries are actively developed and researched.

Examples of secondary battery technologies are nickel-cadmium, nickel-hybrid, nickel-zinc, and lithium-ion. Among them, the lithium-ion battery is rechargeable and its size can be reduced and the capacity can be increased. Further, the operation voltage of the lithium-ion battery and the energy concentration per a unit weight are high, such that it has been widely used in various types of electronic devices.

### SUMMARY OF CERTAIN INVENTIVE ASPECTS

One aspect is a cap-up plate that is used for the cap assembly of a secondary battery and makes it possible to increase the size of an internal gas outlet while improving weldability.

Another aspect is a cylindrical secondary battery that is more suitable for manufacturing a battery pack by having the cap-up plate.

Another aspect is a cap-up plate for a cap assembly of a secondary battery that includes: a base plate; and a terminal that protrudes from one side of the base plate and has a flat portion. The end of the flat portion disposed to overlap the base plate while extending from the joint of the base plate and the terminal toward the base plate.

In one embodiment, the terminal has a curved portion between the flat portion and the base plate. The curved portion is bent at an angle larger than the right angle with respect to the base plate, from the joint with the base plate.

In one embodiment, the curved portion has at least one opening. The at least one opening may be composed of a plurality of openings positioned at a regular distance in the curved portion.

In one embodiment, the terminal may be positioned at the center portion of the base plate.

In one embodiment, the base plate may have a circular ring shape surrounding the terminal.

Another aspect of the present invention is a cylindrical secondary battery that includes: a cylindrical can having an upper end opening; an electrode assembly that is accommodated in the cylindrical can; and a cap assembly including a safety vent that covers the upper end opening and deforms or breaks off when the pressure inside the cylindrical can increases, and a cap-up plate that is connected to one side of the safety vent and transmits the current of the electrode assembly to the outside. The cap-up plate is the cap-up plate as claimed in any one of the embodiment described above.

In one embodiment, the cap assembly further has a secondary safety element on one side of the safety vent. The secondary safety element is electrically connected in a series between the electrode assembly and the cap-up plate.

In one embodiment, the cylindrical secondary battery further includes a gasket that is disposed between the cylindrical can and the cap assembly.

Another aspect is a cap-up plate for a cap assembly of a secondary battery, comprising: a base plate; and a terminal extending from a portion of the base plate, wherein the terminal has a flat portion substantially parallel with the base plate, and wherein the flat portion comprises an end which is located over the portion of the base plate, wherein the end of the flat portion overlaps with the portion of the base plate along a direction substantially perpendicular to the base plate.

In the above cap-up plate, the terminal has a curved portion interconnecting the portion of the base plate and the end of the flat portion, and wherein the curved portion forms an obtuse angle with respect to the base plate. In the above cap-up plate, at least one opening is defined in the curved portion. In the above cap-up plate, the at least one opening comprises a plurality of openings positioned at a regular distance in the curved portion. In the above cap-up plate, the terminal is positioned at the center portion of the base plate. In the above cap-up plate, the base plate has a circular ring shape surrounding the terminal. In the above cap-up plate, the flat portion has a circular ring shape having a diameter. In the above cap-up plate, the diameter of the base plate is greater than the diameter of the flat portion. In the above cap-up plate, the terminal comprises a connection portion which has a diameter and contacts the base plate, and wherein the diameter of the connection portion is less than the diameter of the flat portion.

Another aspect is a cylindrical secondary battery comprising: a cylindrical can having an upper end opening; an electrode assembly accommodated in the cylindrical can; and a cap-up plate electrically connected to the electrode assembly and defining a current channel between the electrode assembly and external devices, wherein the cap-up plate comprises: i) a base plate and ii) a terminal that protrudes extending from one side a portion of the base plate, and wherein the terminal has a flat portion substantially parallel with the base plate, and wherein the flat portion comprises an end which is located over the portion of the base plate, wherein the end of the flat portion disposed to overlaps with the portion of the base plate along a direction substantially perpendicular to the base plate while extending from the joint of the base plate and the terminal toward.

The above battery further comprises a cap assembly which includes a safety vent and the cap-up plate, wherein the safety vent covers the upper end opening and is configured to deform or break off when the pressure inside the cylindrical can increases. In the above battery, the cap assembly further comprises a secondary safety element formed on one side of the safety vent and electrically connected in series between the electrode assembly and the cap-up plate. The above battery further comprises a gasket disposed between the cylindrical can and the cap assembly. In the above battery, the base plate and the flat portion have a ring shape and first and second diameters, respectively, and wherein the first diameter is greater than the second diameter. In the above battery, the terminal comprises a ring-shaped connection portion which has a diameter and contacts the base plate, and wherein the diameter of the connection portion is less than the diameter of the flat portion.

Another aspect is a cap-up plate for a cap assembly of a secondary battery, comprising: a first plate comprising a contacting portion; a second plate substantially parallel with the first plate, wherein the second plate comprises an end which is located over the contacting portion of the base plate; and a connection portion interconnecting the contacting portion of the first plate and the end of the second plate, wherein the connection portion extends upwardly and outwardly from the contacting portion of the first plate toward the end of the second plate.

In the above cap-up plate, the first plate is a base plate of the battery, and wherein the second plate and connection portion forms a terminal of the battery. In the above cap-up plate, the connection portion forms an obtuse angle with respect to the first plate. In the above cap-up plate, at least one opening is defined in the connection portion. In the above cap-up plate, each of the first and second plates has a circular ring shape, and wherein the diameter of the first plate is greater than that of the second plate.

### BRIEF DESCRIPTION OF THE DRAWINGS

FIG. 1 is a schematic perspective view of a cap-up plate according to an embodiment of the present invention.

FIG. 2 is a schematic perspective view of a cap-up plate according to another embodiment of the present invention.

FIG. 3 is a schematic cross-sectional view of the cap-up plate of FIG. 2.

FIG. 4 is a projection view of the cap-up plate of FIG. 2.

FIG. 5 is a partial cross-sectional view of a cylindrical secondary battery having a cap-up plate according to an embodiment of the present invention.

### DETAILED DESCRIPTION OF EXEMPLARY EMBODIMENTS

Generally, the packaging for a lithium-ion battery can be classified into a polygonal or cylindrical can and a pouch type case, in accordance with the shape of a case. The cylindrical secondary battery generally includes: i) an electrode assembly with a cathode plate, an anode plate, and a separator wound in a jelly-roll configuration, ii) a cylindrical can that accommodates the electrode assembly and an electrolyte, and iii) a cap assembly that seals the cylindrical cap and forms a current channel between the electrode assembly and external devices.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

In describing the embodiments, well-known functions or constructions will not be described in detail. In addition, it will be appreciated that like reference numerals refer to like elements throughout even though they are shown in different figures. Further, when a first element is described as being coupled to a second element, the first element may be not only directly coupled to the second element but may also be indirectly coupled to the second element via a third element. Moreover, when a first layer is provided on a second layer, the first layer may be provided directly on the second layer or a third layer may be interposed therebetween. Besides, in the figures, the thickness and sizes of each layer may be exaggerated for convenience of description and clarity and may be different from the actual thickness and size.

FIG. 1 is a schematic perspective view of a cap-up plate according to an embodiment of the present invention.

In one embodiment, as shown in FIG. 1, a cap-up plate 10 includes a base plate (or a first plate) 12 and a terminal 14 protruding from one side (or a portion) of the base plate 12. The terminal 14 may have a flat portion (or a second plate) 14a and a curved portion (or a connection portion) 16 connecting the flat portion 14a with the base plate 12.

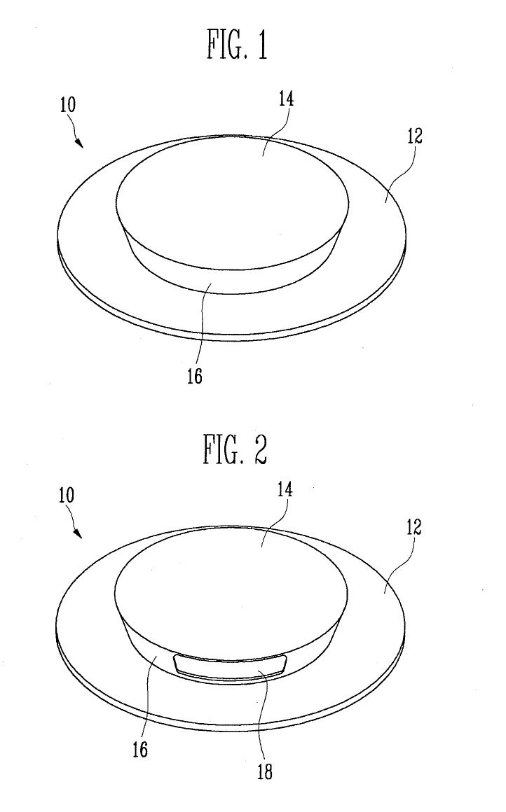

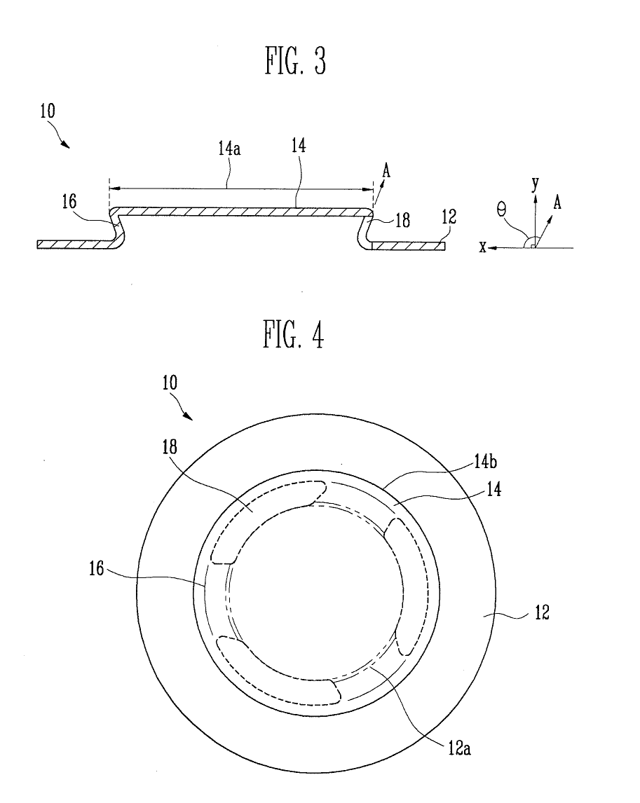

In one embodiment, the end of the flat portion 14a of the terminal 14 is disposed to overlap with the base plate 12 while extending toward the base plate 12 from the joint of the base plate 12 and the terminal 14 or the curved portion 16 and the base plate 12. In one embodiment, the terminal 14 extends from a portion of the base plate 12. The flat portion 14a may be substantially parallel with the base plate 12. The flat portion may include an end which is located over the portion of the base plate. The end of the flat portion 14a may overlap with the portion of the base plate 12 along a direction substantially perpendicular to the base plate 12. The terminal 14 may include a ring-shaped connection portion which has a diameter and contacts the base plate 12, and the diameter of the connection portion may be less than the diameter of the flat portion 14a (See, for example, FIGS. 1 and 2).

According to this configuration, a narrow flat portion, for example, having an about 4.0 mm diameter is expanded, and accordingly, it becomes easy to weld an external device, such as a connection terminal, to the flat portion 14a.

The base plate 12 and the terminal 14 may be integrally formed by forming a single member. The single member may be a conductive material, such as an aluminum alloy and a SPCE coated with nickel.

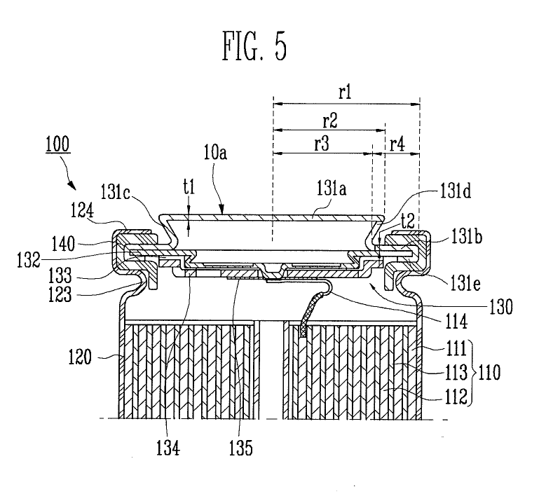

In one embodiment, the curved portion has at least one opening 18. For example, three openings are shown in FIG. 4 for the purpose of convenience.

In one embodiment, the terminal 14 is positioned at the center of the base plate 12. The base plate 12 defines the flange of the terminal 14. The base plate may have a circular ring shape surrounding the terminal 14. The diameter of the base plate 12 may be greater than that of the flat portion 14a.

The flat portion 14a is basically the portion where the flat outer surface of the terminal 14 is formed. The flat portion 14a may have flexible flatness. For example, the flat portion 14a may be slightly concave or convex. The flat portion 14a may contact the bottom of a can or the weld surface of a separate connection terminal, such as an inter-connector for connecting two cylindrical secondary batteries, which face the terminal of the cylindrical secondary battery in manufacturing a battery pack, and is welded to the bottom of the can or the weld surface. Further, it may function as a current channel of a cylindrical secondary battery having the cap-up plate 10. When the flat portion 14a is wide, it is more suitable for high-current flow.

In one embodiment, the curved portion 16 is positioned between the base plate 12 and the flat portion 14a such that the flat portion 14a protrudes at a predetermined distance from one side of the base plate 12.

In one embodiment, the curved portion 16 of the cap-up plate 10, as shown in FIG. 3, bends at a predetermined angle θ greater than 90° (i.e., forming an obtuse angle) with respect to the base plate 12 from the joint of the curved portion and the base plate 12. In one embodiment, the curved portion 16 extends in the direction A that is bent at a predetermined angle larger than the right angle with respect to the x-direction in which the base plate 12 extends.

The area of the flat portion 14a may be increased by the curved portion 16. That is, as shown in FIG. 4, the end 14b of the flat portion 14a extends outside to overlap the base plate 12 with respect to the y direction of FIG. 3, at the joint 12a of the curved portion 16 and the base plate 12.

In one embodiment, the opening 18 increases in size compared with a comparative example where the intermediate portion between the end of the flat portion and the base plate is formed perpendicular to the base plate and thus there is no overlap therebetween. In the FIG. 3 embodiment, since the opening is positioned at an angle in the direction A, the length of the opening 18 in the direction A is greater than the length in the y-direction of an opening of the comparative example. Accordingly, assuming that the lengths of the openings are the same in the direction (e.g. z-direction) which is perpendicular to both of the x-direction and the y-direction, the area of the opening 18 of this embodiment is larger than the openings of the comparative example. In this embodiment, gas can more easily flow (blown out), thereby improving stability of the cylindrical secondary battery.

FIG. 5 is a partial cross-sectional view of a cylindrical secondary battery having a cap-up plate according to an embodiment of the present invention.

In one embodiment, as shown in FIG. 5, a cylindrical secondary battery 100 includes i) an electrode assembly 110, ii) a cylindrical can 120 in which the electrode assembly 110 is inserted, iii) a cap assembly 130 that is fitted in the upper end portion of the cylindrical cap 120, with the electrode assembly 110 inserted in the cylindrical can 120, and iv) a gasket 140 that is disposed on the inner circumferential surface of the upper end opening of the cylindrical can 120 where the cap assembly 130 is seated.

In the FIG. 5 embodiment, the cap-up plate 10a of the cap assembly 130 is substantially the same as the cap-up plate described above with reference to FIGS. 2 to 4, except for a beading portion 131e, which is described below.

In the FIG. 5 embodiment, the edge of the flat portion of the terminal extends toward a base plate 131b from the joint of the terminal 131a and the base plate 131b to overlap the base plate 131b. For example, when the cap-up plate 10a has a circular shape and a radius of r1, the distance r3 from the center to the joint of the terminal 131a to the base plate 131b is a distance obtained by subtracting the width r4 of the base plate 131b from the radius r1 of the cap-up plate 10a. Therefore, the radius r2 of the terminal 131a of this embodiment is larger than the distance r3.

Thus, the area of the flat portion increases. Further, an opening 131d formed in an inclined curved portion 131c also increases in size. Therefore, it is possible to improve weldability and stability of the cylindrical secondary battery 100.

In one embodiment, the electrode assembly 110 includes i) a cathode plate 111 having a cathode active material coated on a cathode collector, ii) an anode plate 112 having an anode active material coated on an anode collector, and iii) a separator 113 that is disposed between the cathode plate 111 and the anode plate 112 and wound in a jelly-roll shape to electrically insulate the cathode plate 111 and the anode plate 112. In one embodiment, a cathode tap 114 is connected to the cap assembly 130 at the upper portion of the electrode assembly 110 and an anode tap (not shown) is connected to the bottom (not shown) of the cylindrical can 120 at the lower portion.

The cylindrical can 120 has a cylindrical side plate (not shown) having a predetermined diameter to form a space where the electrode assembly 110 is received, and a lower plate (not shown) sealing the lower portion of the side plate. The cylindrical can 120, for example, may be formed by machining, such as deep drawing, light conductive metal, such as aluminum or an aluminum alloy. The upper end opening of the cylindrical can 120 is open and closed after the electrode assembly 100 is inserted. A beading portion 123 may be formed at the upper portion of the cylindrical can 120 to prevent movement of the electrode assembly 100. Further, a crimped portion 124 may be formed at the uppermost end of the cylindrical can 120 to fix the cap assembly 130. The crimped portion 124 is provided to compress the cap assembly through the gasket 140 interposed therebetween.

In one embodiment, the can assembly 130 has the cap-up plate 10a and a safety vent 132. The cap-up plate 10a is electrically connected with the electrode assembly 110 and defines a current channel between the electrode assembly 110 and external devices. The safety vent 132 may be disposed with a portion of the upper surface contacting a lower surface of the cap-up plate 10a to discharge internal gas while blocking current when an abnormal internal pressure is generated in the cylindrical can 120. Further, the can assembly 130 may include i) a can-down 134 that is disposed under the safety vent 132, ii) an insulator 133 that is disposed between the safety vent 132 and the cap-down 134, and iii) a sub-plate 135 that is fixed to the lower surface of the cap-down and where the cathode tap 114 is attached.

In one embodiment, the cap-up plate 10a includes the base plate 131b that is formed of a circular plate and the terminal 131a of which the center portion protrudes outside. The terminal 131a is used for electrical connection with the outside. In one embodiment, the terminal 131a has a flat portion and the curved portion 131c connecting the flat portion with the base plate 131b. The curved portion 131c may have the opening 131d that defines a gas channel. Further, the cap-up plate 10a may have the beading portion 131e surrounding the end of the safety vent 132 at the end of the base plate 131b. In one embodiment, the beading portion 131e supports the safety vent 132 such that the safety vent is in close contact with one side of the cap-up plate 10a.

When the beading portion 131e is formed, the thickness t2 of the base plate 131b may be smaller than the thickness t1 of the terminal 131a to maintain or improve sealability without substantially increasing the thickness of the side end of the cap-up plate 10a.

Though not shown in the figures, a positive temperature coefficient thermistor (PTC) element, which is a secondary protection element, may be further provided between the cap-up plate 10a and the safety vent 132.

In another embodiment, a cylindrical secondary battery having the cap-up plate 10 of FIG. 1 may be provided. In this case, the cylindrical secondary battery may have a separate vent hole. For example, it has a vent hole formed in a base plate 12 of a cap-up plate 10 or a cylindrical can, similar to a vent hole of a cap assembly that is welded to a polygonal cap of a polygonal secondary battery.

According to at least one embodiment, it is possible to easily expand the flat portion of the terminal by forming the curved portion at an angle to the outside, when forming the terminal of the cap-up plate. Therefore, it is possible to improve weldability of the cap-up plate to an external device by the wide flat portion of the terminal. Further, it is possible to easily blow out gas when the pressure inside the cylindrical secondary battery excessively increases, by increasing the opening (vent hole) formed between the flat portion and the periphery of the terminal. Therefore, it is possible to improve stability of the cylindrical secondary battery.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A cap-up plate for a cap assembly of a secondary battery, comprising:
a base plate; and
a terminal extending from a portion of the base plate, wherein the terminal has a flat portion substantially parallel with the base plate, and wherein the flat portion comprises an end,
wherein the end of the flat portion overlaps with the portion of the base plate along a direction substantially perpendicular to the base plate.

2. The cap-up plate as claimed in claim 1, wherein the terminal has a curved portion interconnecting the portion of the base plate and the end of the flat portion,
and wherein the curved portion forms an obtuse angle with respect to the base plate.

3. The cap-up plate as claimed in claim 2, wherein at least one opening is defined in the curved portion.

4. The cap-up plate as claimed in claim 3, wherein the at least one opening comprises a plurality of openings positioned at a regular distance in the curved portion.

5. The cap-up plate as claimed in claim 1, wherein the terminal is positioned at the center portion of the base plate.

6. The cap-up plate as claimed in claim 1, wherein the base plate has a circular ring shape surrounding the terminal, and wherein the base plate has inner and outer diameters.

7. The cap-up plate as claimed in claim 6, wherein the flat portion has a circular ring shape having a diameter.

8. The cap-up plate as claimed in claim 7, wherein the outer diameter of the base plate is greater than the diameter of the flat portion.

9. The cap-up plate as claimed in claim 7, wherein the terminal comprises a connection portion, wherein the bottom of the connection portion has a diameter and contacts the base plate, and wherein the diameter of the bottom of the connection portion is less than the diameter of the flat portion.

10. A cylindrical secondary battery comprising:
a cylindrical can having an upper end opening;
an electrode assembly accommodated in the cylindrical can; and
a cap-up plate electrically connected to the electrode assembly and defining a current channel between the electrode assembly and external devices, wherein the cap-up plate comprises: i) a base plate; and ii) a terminal extending from a portion of the base plate, wherein the terminal has a flat portion substantially parallel with the base plate, and wherein the flat portion comprises an end which is located over the portion of the base plate, wherein the end of the flat portion overlaps with the portion of the base plate along a direction substantially perpendicular to the base plate.

11. The cylindrical secondary battery as claimed in claim 10, further comprising a cap assembly which includes a safety vent and the cap-up plate, wherein the safety vent covers the upper end opening and is configured to deform or break off when the pressure inside the cylindrical can increases.

12. The cylindrical secondary battery as claimed in claim 11, wherein the cap assembly further comprises a secondary safety element formed on one side of the safety vent and electrically connected in series between the electrode assembly and the cap-up plate.

13. The cylindrical secondary battery as claimed in claim 11, further comprising a gasket disposed between the cylindrical can and the cap assembly.

14. The cylindrical secondary battery as claimed in claim 10, wherein the base plate and the flat portion have a ring shape, wherein the base plate has inner and outer diameters, wherein the flat portion has a diameter, and wherein the outer diameter of the base plate is greater than the diameter of the flat portion.

15. The cap-up plate as claimed in claim 14, wherein the terminal comprises a connection portion, wherein the bottom of the connection portion has a diameter and contacts the base plate, and wherein the diameter of the bottom of the connection portion is less than the diameter of the flat portion.

16. A cap-up plate for a cap assembly of a secondary battery, comprising:
a first plate comprising a contacting portion;
a second plate substantially parallel with the first plate, wherein the second plate comprises an end which is located over the contacting portion of the base plate; and
a connection portion interconnecting the contacting portion of the first plate and the end of the second plate, wherein the connection portion extends upwardly and outwardly from the contacting portion of the first plate toward the end of the second plate.

17. The cap-up plate as claimed in claim 16, wherein the first plate is a base plate of the battery, and wherein the second plate and connection portion forms a terminal of the battery.

18. The cap-up plate as claimed in claim 16, wherein the connection portion forms an obtuse angle with respect to the first plate.

19. The cap-up plate as claimed in claim 16, wherein at least one opening is defined in the connection portion.

20. The cap-up plate as claimed in claim 16, wherein each of the first and second plates has a circular ring shape, and wherein the diameter of the first plate is greater than that of the second plate.
